(19) United States
(12) Patent Application Publication
(10) Pub. No.: US 2014/0337769 A1
(43) Pub. Date: Nov. 13, 2014

(54) METHOD AND APPARATUS FOR USING ELECTRONIC DEVICE

(71) Applicant: Samsung Electronics Co., Ltd., Suwon-si (KR)

(72) Inventors: Hyeong-Seok KIM, Seoul (KR); Gi-Beom KIM, Yongin-si (KR); Hyuk KANG, Yongin-si (KR); Yu-Jin LEE, Suwon-si (KR); Hyun-Chul CHOI, Seoul (KR)

(73) Assignee: Samsung Electronics Co., Ltd., Suwon-si (KR)

(21) Appl. No.: 14/275,151

(22) Filed: May 12, 2014

(30) Foreign Application Priority Data
May 13, 2013 (KR) 10-2013-0053798

(51) Int. Cl. G06F 3/0484; G06F 3/0488; G06F 3/14

(52) U.S. Cl. CPC G06F 3/04847; G06F 3/1454; G06F 3/0488
USPC 715/761

(57) ABSTRACT

A method of using an electronic device is provided. The method includes receiving a request for a screen share mode in which to share a screen of a running application, transmitting display data resulting from running the application to a predetermined external output device, displaying a predetermined input interface on a display screen of the electronic device, and controlling operations of the application according to inputs to the displayed input interface.

### CROSS-REFERENCE TO RELATED APPLICATION(S)

This application claims the benefit under 35 U.S.C. §119(a) of a Korean patent application filed on May 13, 2013 in the Korean Intellectual Property Office and assigned Serial No. 10-2013-0053798, the entire disclosure of which is hereby incorporated by reference.

### TECHNICAL FIELD

The present disclosure relates to an electronic device. More particularly, the present disclosure relates to an input interface in a screen share mode.

### BACKGROUND

Ever-evolving electronic devices, such as smartphones, have high-end and multi-functional hardware and software. These electronic devices provide various functions, such as gaming, multimedia content playback, and the like in addition to simple voice and data communication.

For example, users may play games or enjoy multimedia content, such as photos or movies.

Since electronic devices such as smartphones or tablets have size restrictions due to their portability, users might need to use an output device having a bigger display area than that of the electronic device having a smaller screen to play games or multimedia content. In response to this need, smartphone makers provide related functions, such as AllShare Cast® by Samsung or AirPlay® by Apple.

For example, the user may direct a screen playing on his/her electronic device (e.g., a portable terminal) to be output to a display device having a bigger screen, such as a television, and then play the game while viewing the screen output on the television.

FIG. 1A illustrates a case where a portable terminal outputs its execution screen to an external device with a big screen according to the related art.

Referring to FIG. 1A as an example, the user arranges an output device 10 and an electronic device 20 to be synchronized to display the same screen, and then manipulates the electronic device 20 (e.g., by inputting touch inputs) to play a game. The outputting device 10 only displays the screen of the game being played on electronic device 20, and the user has to make inputs while viewing the screen of the electronic device 20, which causes inconvenience to the user.

The aforementioned related technology has an advantage of output a gaming screen or multimedia playback screen originating from an electronic device with a smaller screen to an output device with a bigger display, such as television, but the advantage is compromised by the fact that the user has to make inputs to play games or multimedia while continuously checking the electronic device 20, and thus has to watch the small screen of the electronic device 20.

In other words, in case of such related technology like mirroring the output of a screen of an electronic device to an output device (e.g., a television) wirelessly or via cable, an appropriate interface for the mirroring has not yet been provided.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an input interface optimized to transmit and present display data of an electronic device to an external output device, thereby efficiently using a function to output display data to the external output device.

In accordance with an aspect of the present disclosure, a method of using an electronic device is provided. The method includes receiving a request for a screen share mode in which to share a screen of a running application, transmitting display data resulting from running the application to an external output device, displaying an input interface on a display screen of the electronic device, and controlling operations of the application according to inputs to the displayed input interface.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1A illustrates a case where a portable terminal outputs its execution screen to an external device with a big screen according to the related art;

FIG. 1B is a schematic diagram of an electronic device according to an embodiment of the present disclosure;

FIG. 2 is a flowchart illustrating a process of using a portable terminal according to an embodiment of the present disclosure;

FIG. 3 illustrates a case where a portable terminal outputs its execution screen to an external device with a big screen according to an embodiment of the present disclosure;

FIG. 4A illustrates input interfaces according to various embodiments of the present disclosure;

FIG. 4B illustrates an input interface list according to an embodiment of the present disclosure;

FIG. 4C illustrates an external output device according to an embodiment of the present disclosure;

FIG. 4D illustrates how to set up an input interface according to an embodiment of the present disclosure; and

FIG. 4E illustrates user inputs to an input interface according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the present disclosure. Accordingly, it should be apparent to those skilled in the art that the following description of various embodiments of the present disclosure is provided for illustration purposes only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

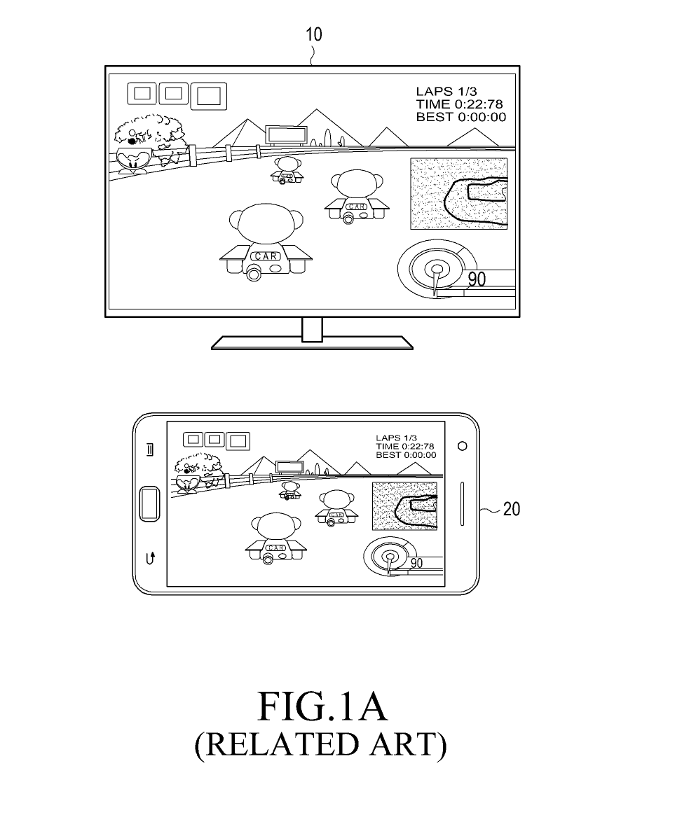

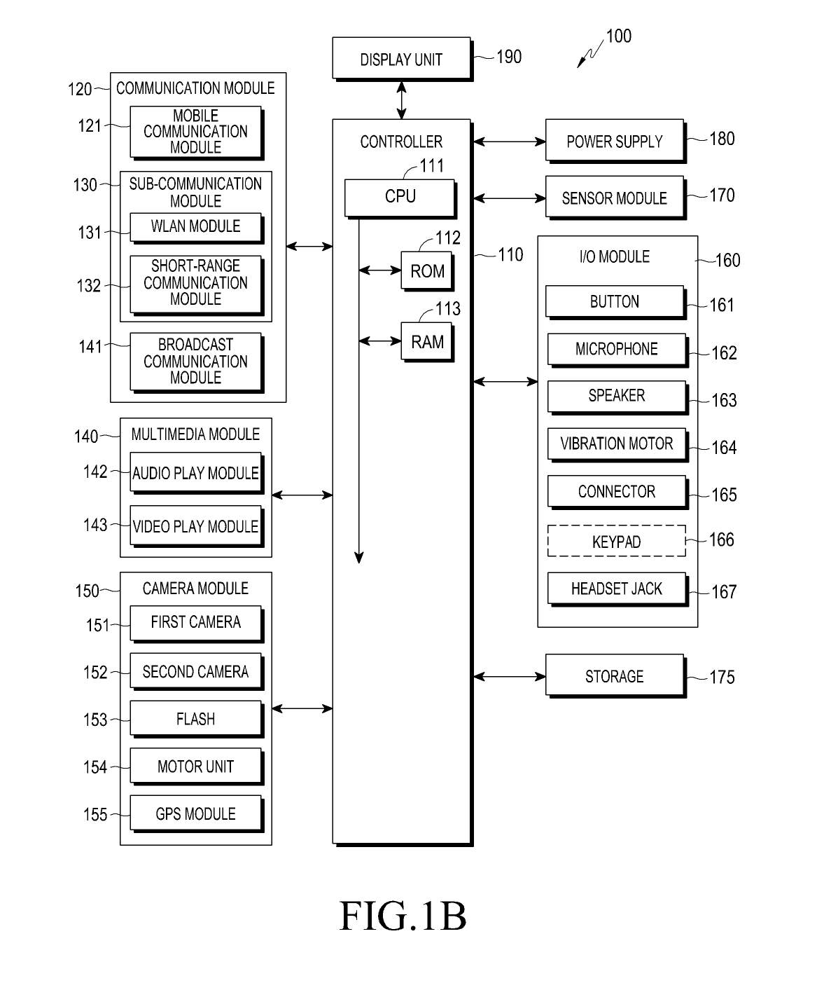

FIG. 1B is a schematic diagram of an electronic device according to an embodiment of the present disclosure.

Various embodiments of the present disclosure are implemented by the electronic device, which is assumed to be a portable terminal that is easy to carry in terms of its weight and volume. As the electronic device, similar feature phones and devices driven by Bada®, Tizen®, Windows® series (for example, Windows 8), iOS®, and Android, such as smartphones and tablets may be enumerated. Additionally, the electronic device may be a notebook, digital camera, video phone, etc. It will be obvious to a person of ordinary skill in the art that the electronic device is not limited to the aforementioned examples.

Referring to FIG. 1B, the electronic device 100 may be connected to an external device (not shown) by using an external device connection, such as a sub-communication module 130, a connector 165, and a headset jack 167. The “external device” may include a variety of devices, such as earphones, external speakers, Universal Serial Bus (USB) memories, chargers, cradles/docks, Digital Multimedia Broadcasting (DMB) antennas, mobile payment related devices, health care devices (e.g., blood sugar testers), game consoles, vehicle navigations, or the like, which are removable from the electronic device 100 and connected thereto via cable. The “external device” may also include a short range communication device that may be wirelessly connected to the electronic device 100 via short range communication, such as Bluetooth, Near Field Communication (NFC), etc., and a Wireless Fidelity (WiFi) Direct communication device, a wireless Access Point (AP), etc. Furthermore, the external device may include any other device, such as a cell phone, smartphone, tablet PC, desktop PC, and server.

The electronic device 100 may also include a controller 110, a communication module 120 which includes a mobile communication module 121, the sub-communication module 130, a multimedia module 140, a camera module 150, a Global Positioning System (GPS) module 155, an input/output module 160, a sensor module 170, a storage 175, a power supply 180, and a display unit 190 which may be a touch screen. The sub-communication module 130 may include at least one of Wireless Local Area Network (WLAN) 131 and a short-range communication module 132, and the multimedia module 140 includes at least one of a broadcast communication module 141, an audio play module 142, and a video play module 143. The camera module 150 may include at least one of a first camera 151 and a second camera 152, a motor unit 154; and the input/output module 160 includes one or more buttons 161, a microphone 162, a speaker 163, a vibration motor 164, a connector 165, and a keypad 166.

The mobile communication module 121 connects the electronic device 100 to an external device through mobile communication using at least one or more antennas (not shown) under control of the controller 110. The mobile communication module 121 transmits/receives wireless signals for voice calls, video conference calls, Short Message Service (SMS) messages, or Multimedia Message Service (MMS) messages to/from a cell phone (not shown), a smartphone (not shown), a tablet PC (not shown), or another device not shown), the phones having phone numbers entered into the electronic device 100.

The sub-communication module 130 may include at least one of the WLAN module 131 and the short-range communication module 132. For example, the sub-communication module 130 may include either the WLAN module 131 or the-short range communication module 132, or both.

The WLAN module 131 may include a WiFi module and be connected to the Internet in a place where there is a wireless Access Point (AP) (not shown), in connection with the controller 110. The WLAN module 131 supports the Institute of Electrical and Electronic Engineers' (IEEE's) WLAN standard IEEE 802.11x.

The short-range communication module 132 supports short-range communication in connection with the controller 110. The short-range communication module 132 may include a Bluetooth module, an Infrared Data Association (IrDA) module, an NFC module, etc.

In various embodiments of the present disclosure, the controller 110 may transmit or output display data of the electronic device 100 to an external output device in a screen share mode using the WLAN module 131.

The multimedia module 140 may include the broadcast communication module 141, the audio play module 142, or the video play module 143. The broadcast communication module 141 may receive broadcast signals (e.g., television broadcast signals, radio broadcast signals, or data broadcast signals) and additional broadcast information (e.g., Electric Program Guide (EPG) or Electric Service Guide (ESG)) transmitted from a broadcasting station through a broadcast communication antenna (not shown), under control of the controller 110. The audio play module 142 may play digital audio files (e.g., files having extensions, such as mp3, wma, ogg, or way) stored or received under control of the controller 110. The video play module 143 may play digital video files (e.g., files having extensions, such as mpeg, mpg, mp4, avi, move, or mkv) stored or received under control of the controller 110. The video play module 143 may also play digital audio files.

The multimedia module 140 may include the audio play module 142 and the video play module 143 except for the broadcast communication module 141. The audio play module 142 or video play module 143 of the multimedia module 140 may be included in the controller 110.

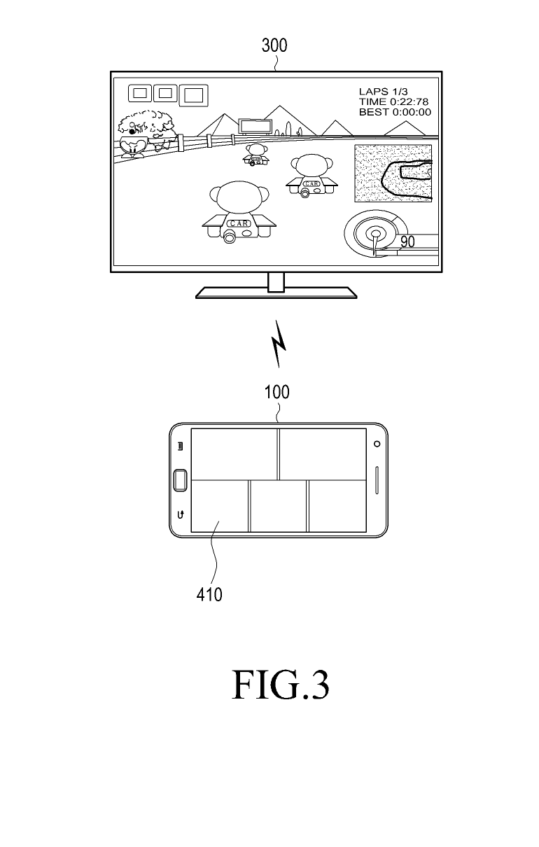

The camera module 150 may include at least one of the first and second cameras 151 and 152 for capturing still images or video images under control of the controller 110. Furthermore, the first or second camera 151 or 152 may include an auxiliary light source (e.g., flash 153, FIG. 3) for providing as much an amount of light as required for capturing. The first camera 151 may be placed on the front of the electronic device 100 and the second camera 152 may be placed on the back of the electronic device 100. In another way, the first and second cameras 151 and 152 are arranged adjacent to each other (e.g., the distance between the first and second cameras 151 and 152 may be within the range between 1 to 8 cm), capturing 3D still images or 3D video images.

The GPS module 155 receives radio signals from a plurality of GPS satellites (not shown) in Earth's orbit, and may calculate the position of the electronic device 100 by using time of arrival from the GPS satellites to the electronic device 100.

The input/output module 160 may include at least one or more buttons 161, the microphone 162, the speaker 163, the vibration motor 164, the connector 165, and the keypad 166.

The one or more buttons 161 may be arranged on the front, side, or back of the housing of the electronic device 100, and may include at least one of power/lock button (not shown), volume button (not shown), menu button, home button, back button, and search button.

The microphone 162 generates electric signals by receiving voice or sound under control of the controller 110.

The speaker 163 may output sounds corresponding to various signals (e.g., radio signals, broadcast signals, digital audio files, digital video files or photography signals) from the mobile communication module 121, sub-communication module 130, multimedia module 140, or camera module 150 to the outside under control of the controller 110. The speaker 163 may output sounds (e.g., button-press sounds or ringback tones) that correspond to functions performed by the electronic device 100. There may be one or multiple speakers 163 arranged in a proper position or proper positions in the housing of the electronic device 100.

The vibration motor 164 may convert electric signals to a mechanical vibration under control of the controller 110. For example, the electronic device 100 in a vibrating mode operates the vibrating motor 164 when receiving a voice call from another device (not shown). There may be one or more vibration motors 164 inside the housing of the electronic device 100. The vibration motor 164 may be driven in response to a touch activity or continuous touches of a user over the touch screen 190.

The connector 165 may be used as an interface for connecting the electronic device 100 to the external device (not shown) or a power source (not shown). Under control of the controller 110, the electronic device 100 may transmit data stored in the storage 175 of the electronic device 100 to the external device via a cable connected to the connector 165, or receive data from the external device. Furthermore, the electronic device 100 may be powered by the power source via a cable connected to the connector 165 or may charge the battery (not shown) with the power source.

In various embodiments of the present disclosure, the controller 110 may transmit or output display data of the electronic device 100 to an external output device in a screen share mode using the connector 165.

The keypad 166 may receive key inputs from the user to control the electronic device 100. The keypad 166 may include a physical keypad (not shown) formed in the electronic device 100, or a virtual keypad (not shown) displayed on the touchscreen 190. The mechanical keypad formed in the electronic device 100 may be excluded depending on the performance or structure of the electronic device 100.

A headset (not shown) may be inserted into the headset jack 167 and thus connected to the electronic device 100.

The sensor module 170 may include at least one sensor for detecting a status of the electronic device 100. For example, the sensor module 170 may include a proximity sensor for detecting proximity of a user to the electronic device 100; a illumination sensor (not shown) for detecting an amount of ambient light of the electronic device 100; a motion sensor (not shown) for detecting the motion of the electronic device 100 (e.g., rotation of the electronic device 100, acceleration or vibration applied to the electronic device 100); a geomagnetic sensor (not shown) for detecting a direction using the geomagnetic field; a gravity sensor for detecting a direction of gravity action; and an altimeter for detecting an altitude by measuring atmospheric pressure. At least one sensor may detect the status and generate a corresponding signal to transmit to the controller 110. The sensor of the sensor module 170 may be added or removed depending on the performance of the electronic device 100.

The storage 175 may store signals or data input/output according to operations of the mobile communication module 121, the sub-communication module 130, the multimedia module 140, the camera module 150, the GPS module, the input/output module 160, the sensor module 170, the touch screen 190 under control of the controller 110. The storage 175 may store the control programs and applications for controlling the electronic device 100 or the controller 110. The term “storage” refers to the storage 175, or Read-Only Memory (ROM) or Random Access Memory (RAM) in the controller 110.

The storage 175 may further include an external memory, such as Compact Flash (CF), Secure Digital (SD), Micro Secure Digital (Micro-SD), Mini Secure Digital (Mini-SD), extreme Digital (xD), memory stick, and the like. The storage 175 may also include a disc storage device, such as Hard Disc Drive (HDD), Solid State Disc (SSD), and the like.

The power supply 180 may supply power to one or more batteries (not shown) placed inside the housing of the electronic device 100 under control of the controller 110. The one or more batteries power the electronic device 100.

The power supply 180 may supply the electronic device 100 with the power input from the external power source (not shown) via a cable connected to the connector 165. The power supply 180 may also supply the electronic device 100 with wireless power from an external power source using a wireless charging technology.

The display unit 190 may be formed of a Liquid Crystal Display (LCD) or an Organic Light Emitting Diodes (OLED), such as Passive Matrix Organic Light Emitting Diodes (PMOLED) or Active Matrix Organic Light Emitting Diodes (AMOLED, and outputs different pieces of display information. The display unit 190 may include a touch screen (e.g., a Touch Screen Panel (TSP)) and touch screen controller implemented in a resistive, capacitive, infrared, or acoustic wave method. The display unit 190 may also include a controller for a panel that may receive user pen inputs (e.g., S-pen inputs of Samsung) in an electromagnetic induction method.

The display unit 190 may provide the user with a user interface for various services (e.g., call, data transmission, broadcasting, photography services). The display unit 190 may send an analog signal corresponding to at least one touch input to the user interface to the touchscreen controller. The display unit 190 may receive the at least one touch input from user's physical contact (e.g., with fingers including thumb) or via a touchable input device (e.g., a stylus pen).

In various embodiments of the present disclosure, touches are not limited to physical touches by a physical contact of the user or contacts with the touchable input means, but may also include touchless (e.g., keeping a detectable distance less than 1 mm between the touch screen and the user's body or touchable input means).

The touch screen controller converts the analog signal received from the display unit 190 to a digital signal (e.g., XY coordinates) and transmits the digital signal to the controller 110. The controller 110 may control the display unit 190 by using the digital signal received from the touch screen controller. For example, the controller 110 may control an application icon displayed in the display unit 190 to be selected or a corresponding application to run in response to a touch. The touch screen controller may also be incorporated in the controller 110.

The controller 110 may include a central processing unit (CPU) 111, a ROM 112 for storing a control program to control the electronic device 100, and a RAM 113 for storing signals or data input from outside or for being used as a memory space for working results in the electronic device 100. The CPU 111 may operate in a single core, dual core, triple core, or quad core method. The CPU 111, ROM 112, and RAM 113 may be connected to each other via an internal bus.

The controller 110 may control the mobile communication module 121, the sub-communication module 130, the multimedia module 140, the camera module 150, the GPS module, the input/output module 160, the sensor module 170, the storage 175, the power supply 180, and the display unit 190. The controller 110 may perform a method for using the electronic device, the method including a series of operations of receiving a request for a screen share mode in which to share a screen of a running application, transmitting display data resulting from running the application to an external output device, displaying an input interface on a display screen of the electronic device, and controlling operations of the application according to inputs to the displayed input interface. Operations of the controller 110 according to various embodiments of the present disclosure will be described below.

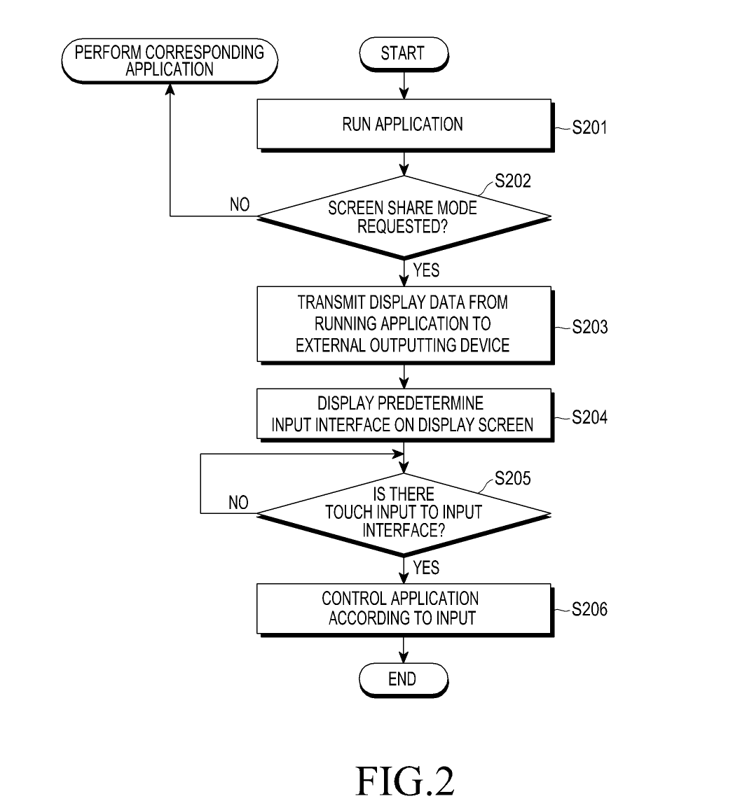

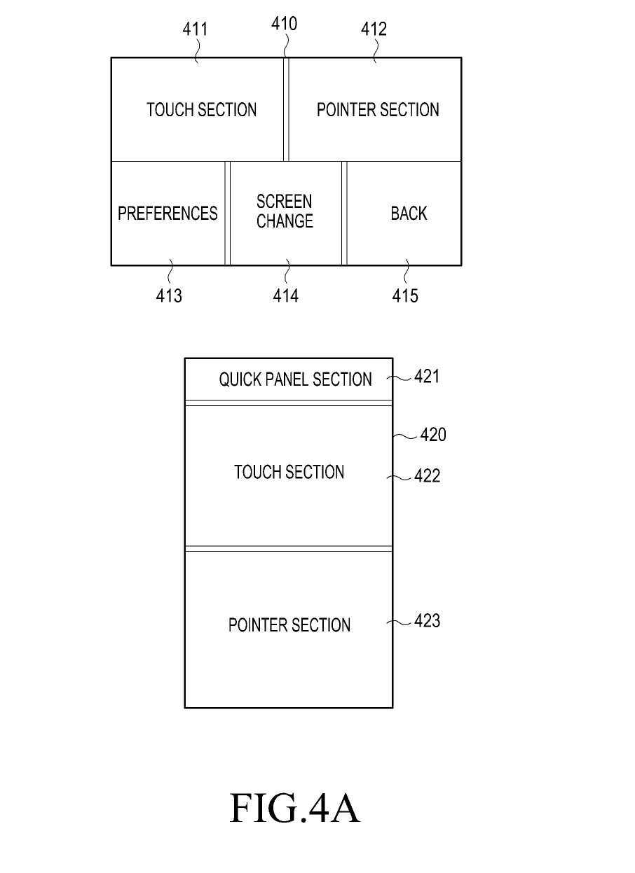

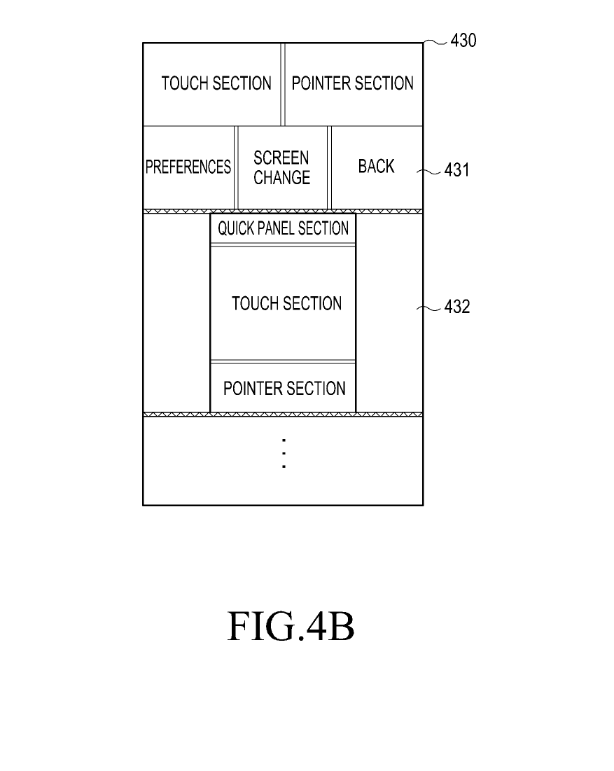

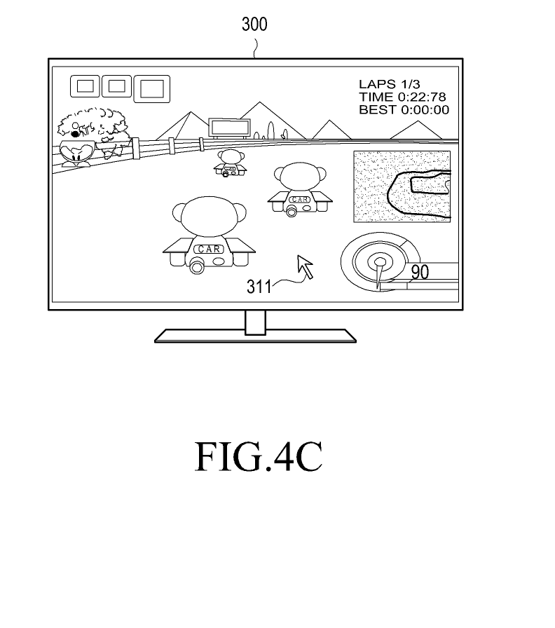

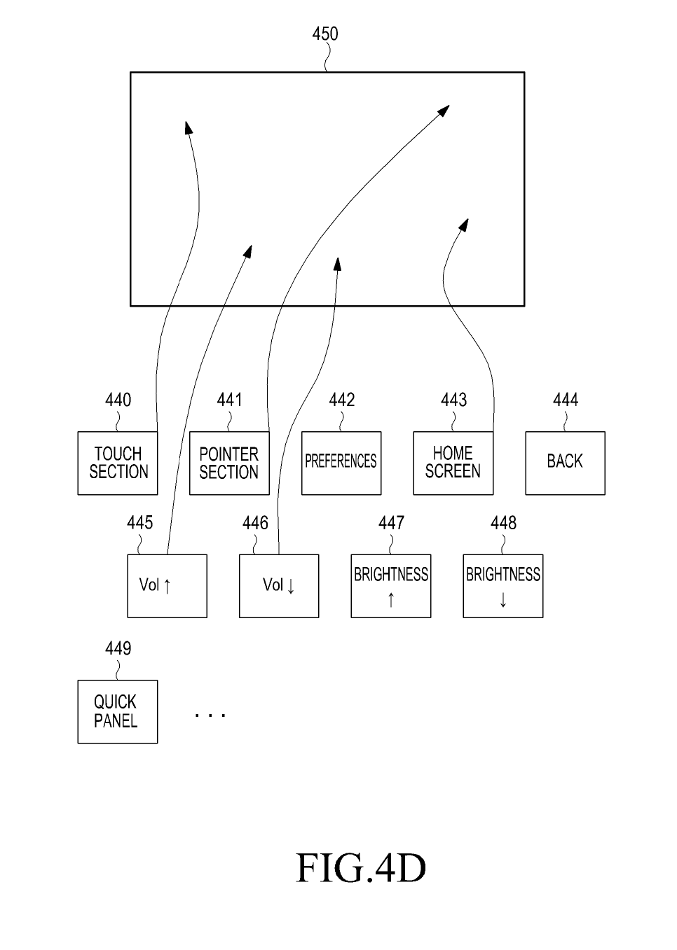

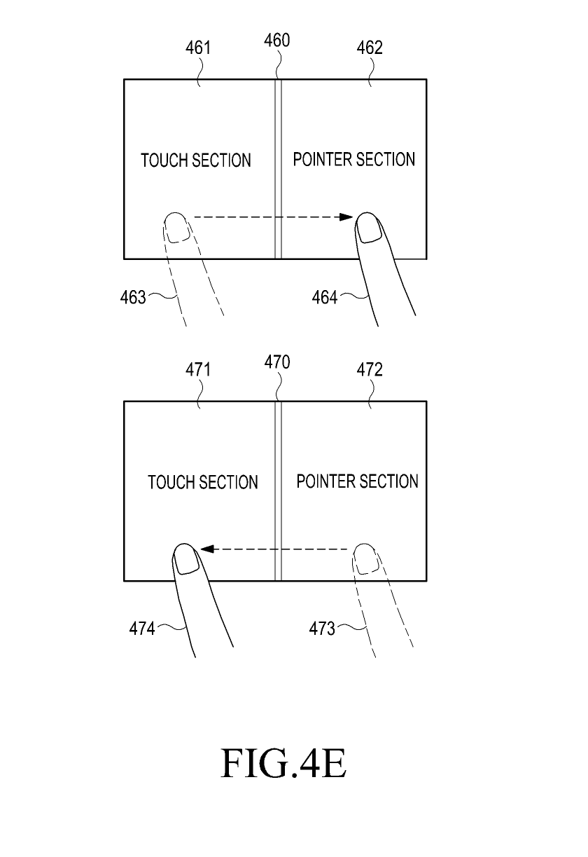

FIG. 2 is a flowchart illustrating a process of using a portable terminal according to an embodiment of the present disclosure. FIG. 3 illustrates a case where a portable terminal outputs its execution screen to an external device with a significantly larger display area according to an embodiment of the present disclosure. FIG. 4A illustrates an input interface list according to embodiments of the present disclosure. FIG. 4B illustrates an input interface list according to an embodiment of the present disclosure. FIG. 4C illustrates an external output device according to an embodiment of the present disclosure. FIG. 4D illustrates how to set up an input interface according to an embodiment of the present disclosure. FIG. 4E illustrates user inputs to an input interface according to an embodiment of the present disclosure. Referring to the figures, various embodiments of the present disclosure will be described below.

After an application runs in operation S201, the controller 110 determines whether a request for entering a screen share mode for the running application has been received in operation S202.

Specifically, a user of the electronic device 100 may run the application (e.g., a game application), and then select an external output device and request to enter the screen share mode.

For example, referring to FIG. 3, the user selects an external output device 300 that receives display data from the electronic device 100 wirelessly, e.g., via Wi-Fi short-range communication, or via a cable (e.g., High-Definition Multimedia Interface (HDMI) cable) and outputs (or displays) the display data, and requests to enter the screen share mode.

The external output device 300 refers to a device that has a bigger screen size or greater resolution of the screen than the display unit 190 of the electronic device 100. The external output device 300 may include, not exclusively, a television, a monitor, a notebook, a tablet, or the like.

The controller 110 transmits display data of the running application to the external output device in operation S203, and controls the display unit 190 to display an input interface on its display screen in operation S204.

In related technology, mirroring synchronizes a display screen of an electronic device with a display screen of an external output device. In other words, in the case of mirroring, display data of the electronic device is displayed in the display screen of the electronic device while being transmitted and displayed in the external output device.

On the contrary, in various embodiments of the present disclosure, while in the screen share mode, the controller 110 controls the display data of an application running in the electronic device 100 to be output (or displayed) to an external output device that may be selected by the user and not to be displayed in the display unit 190.

The controller 110 controls the display unit 190 to display an input interface 410 on its display screen, instead of displaying the display data that is output to the output device 300, in the screen share mode, as shown in FIG. 3.

In various embodiments of the present disclosure, the input interface, such as an input interface 410 or 420 as shown in FIG. 4A, may be obtained by dividing the display screen of the electronic device 100 into a number of sub-screens, each of which may be assigned a input. Then, if a touch input is detected on any of the sub-screens, the electronic device 100 or a running application therein is controlled based on the corresponding input assigned to the sub-screen and the user may see the control result through the external output device 300.

Referring to FIG. 4A, in various embodiments of the present disclosure, the input interface 410 to be displayed on the display screen of the display unit 190 may include input sections, such as a touch section 411, a pointer section 412, a preferences section 413, a screen change section 414, and a back menu section 415.

The touch section 411 includes an area to receive touch inputs, such as tapping, double tapping, flicking, dragging, drag-and-drop, swiping, multi-swiping, pinch zoom-in, pinch zoom-out, long touches or touch and hold, or the like.

The pointer section 412 is an area to control a pointer which may be displayed on a running application. In this regard, since display data of the running application is not displayed on the display screen of the electronic device 100, a pointer 311, as shown in FIG. 4C, may be displayed in the external output device 300 and the user may control the movement of the pointer 311 with touch inputs to the pointer section 412.

The preferences section 413 is an area to provide functions to control operations of the electronic device 100 or to control operations of the running application. For example, if a touch input is detected on the preferences section 413, the controller 110 controls preferences for the running application (e.g., a game application) to be displayed or controls preferences to control operations of the electronic device 100 to be displayed.

The screen change section 414 is an area to provide functions to request to switch screens between the input interface screen and any other screen of the electronic device 100. For example, the user may request the electronic device 100 to change its screen to a home screen instead of the input interface screen with a touch input to the screen change section 414. As another example, while the input interface is displayed in the electronic device 100 and the display data of a running application is displayed in the external output device 300, the user may request the display data of the running application to be replaced in the display screen of the electronic device 100 with a touch input to the screen change section 414.

The back menu section 415 is an area to provide a function of the back button used to change application or menu screens or functions of the electronic device 100.

As another embodiment, the input interface 420 of FIG. 4A may include a quick panel section 421, a touch section 422, or a pointer section 423.

The quick panel section 421 is an area in which one or more setting buttons (or icons) are arranged to quickly control operations (or settings) of the electronic device 100.

The touch section 420 and the pointer section 423 have the same functions as described for the touch section 411 and the pointer section 412 of the input interface 410.

In various embodiments of the present disclosure, upon request for the screen share mode after an application runs in the electronic device 100, the display screen of the electronic device 100 displays an input interface e.g., 410 or 420, which may be determined for each application or may be manually selected by the user.

For example, the controller 110 may display an input interface list 430 including an input interface 431 and an input interface 432 as shown in FIG. 4B, in operation S204. Then, the controller 110 may receive from a user a selection of an input interface to be used and control the selected input interface to be displayed.

Furthermore, before or after the screen share mode, the user may establish the input interface to be displayed in the screen share mode. Referring to FIG. 4D, the user may select an input, e.g., 440, 441, 443, 445, or 446 to set up an input interface 450 from among inputs 440 to 449. After selection of the input 440, 441, 443, 445, or 446, the size of a sub-screen corresponding to the input may also be set. With this, the user may set the number of sub-screens of the input interface to be displayed in the screen share mode, the size of each sub-screen, or an input assigned to each sub-screen.

Referring to back to FIG. 2, the controller 110 determines whether a touch input is made in the displayed input interface in operation S205, and controls a running application according to the touch input in operation S206.

Upon detection of the touch input made in any one of the sub-screens of the displayed input interface, the controller 110 controls operations of the application based on an input assigned to the sub-screen on which the touch input is made. Referring to FIG. 4A, the user may manipulate the running application by making touch inputs with both hands, e.g., the left hand touching the touch section 411 and the right hand touching the pointer section 412. Specifically, after moving a pointer with the right hand touch on the pointer section 411, the user may make the left hand touch on the touch section 411 to perform a pointer action (e.g., selection or execution) at the point where there is the pointer.

In various embodiments of the present disclosure, in controlling operations of an application (or operations of the electronic device 100) with touch inputs to sub-screens, if a touch input to any one of the sub-screens is detected, only the sub-screen on which the touch input is made is activated while remaining sub-screens are deactivated, and operations of the running application may be controlled according to the touch input to the activated sub-screen.

Turning back to FIG. 4A, for example, with the input interface 410 being displayed, if a touch input to the touch section 411 is detected, the controller 110 deactivates sub-screens 412 to 415 to disable them from receiving touch inputs.

This may prevent the input interface from receiving unwanted inputs while the user manipulates the input interface with his/her left, right, or both hands in using the electronic device 100 held in his/her hand.

In various embodiments of the present disclosure, since the electronic device 100 persists in the screen share mode after operation S203 until a separate termination request is made, results (e.g., display screen) of controlling operations of the running application via the input interface displayed on the display screen of the electronic device 100 may be outputted or transmitted to the external output device 300. Therefore, the user may use the application by controlling the application through the input interface in the electronic device 100 and viewing the control results through the external output device 300.

Furthermore, in various embodiments of the present disclosure, if a touch input starting in a sub-screen but ending in another sub-screen is made, the controller 110 may control operations of the running application based on an input assigned for the sub-screen where the touch input begins.

Referring to FIG. 4E, if a touch input 463 and 464 starting in a sub-screen 461 and ending in another sub-screen 462, which are divided by divider 460, is detected, the controller 110 may determine that the touch input 463 and 464, e.g., swiping or touch-and-dragging is made for the sub-screen 461.

The controller 110 may control operations of the running application based on the input assigned for the sub-screen 461 (e.g., the touch section) according to the touch input 463 and 464, and the user may see the control results through the external output device 300.

As another example, a touch input 473 and 474 starting in a sub-screen 472 and ending in another sub-screen 471, which are divided by divider 470, may be detected.

In this case, the controller 110 may determine that the touch input 473 and 474 is made for the sub-screen 472. Since the sub-screen 472 is the pointer section, the controller 110 may control a pointer being displayed on the running application to be moved along the movements of the touch input 473 and 474.

With the aforementioned input interface in various embodiments of the present disclosure, the user may use the screen share mode for the electronic device 100 and the external output device 300 while minimizing the frequency of checking the small display screen of the electronic device 100.

For example, in a case the user runs a game application in the electronic device 100, the user may use the external output device 300 to present the display or output of the game application while using the input interface displayed in the electronic device 100 to control or manipulate the game application.

According to various embodiments of the present disclosure, provided is an input interface which is optimized for a function for an electronic device to output its display data to an external output device, thereby using the function more easily and efficiently.

It will be appreciated that various embodiments of the present disclosure according to the claims and description in the specification can be realized in the form of hardware, software or a combination of hardware and software.

Any such software may be stored in a non-transitory computer readable storage medium. The non-transitory computer readable storage medium stores one or more programs (software modules), the one or more programs comprising instructions, which when executed by one or more processors in an electronic device, cause the electronic device to perform a method of the present disclosure.

Any such software may be stored in the form of volatile or non-volatile storage such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a Compact Disk (CD), Digital Versatile Disc (DVD), magnetic disk or magnetic tape or the like. It will be appreciated that the storage devices and storage media are various embodiments of non-transitory machine-readable storage that are suitable for storing a program or programs comprising instructions that, when executed, implement various embodiments of the present disclosure. Accordingly, various embodiments provide a program comprising code for implementing apparatus or a method as claimed in any one of the claims of this specification and a non-transitory machine-readable storage storing such a program.

While the present disclosure has been shown and described with reference to various embodiments thereof, it will be understood by those of ordinary skill in the art that various changes in form and details may be made therein without departing from the spirit and scope of the present disclosure as defined by the following claims and their equivalents.

What is claimed is:

1. A method of using an electronic device, the method comprising:
receiving a request for a screen share mode in which to share a screen of a running application;
transmitting display data resulting from running the application to an external output device;
displaying an input interface on a display screen of the electronic device; and
controlling operations of the application according to inputs to the displayed input interface.

2. The method of claim 1, wherein the displaying of the input interface comprises:
displaying a list of input interfaces and receiving a selection of an input interface from the displayed list of input interfaces; and
displaying the selected input interface.

3. The method of claim 1, wherein the displaying of the input interface comprises:
dividing the display screen of the electronic device into a certain number of sub-screens, and
displaying the sub-screens, each of which is assigned a corresponding input.

4. The method of claim 3, wherein the controlling of the operations of the application comprises:
upon detection of a touch input to any of the sub-screens, controlling operations of the application based on a corresponding input assigned to the sub-screen where the touch input is detected.

5. The method of claim 3, wherein the controlling of the operations of the application comprises:
activating only a sub-screen on which a touch input is detected, and
controlling operations of the application based on a corresponding input assigned to the activated sub-screen, according to the touch input to the activated sub-screen.

6. The method of claim 5, further comprising:
deactivating other sub-screens than the sub-screen in which the touch input is detected.

7. The method of claim 3, wherein the controlling of the operations of the application comprises:
if a touch input starting in a sub-screen but ending in another sub-screen is made, controlling operations of the application based on the corresponding input is assigned to the sub-screen where the touch input begins, according to the touch input.

8. The method of claim 3, wherein one of the number of sub-screens, a size of each sub-screen and the corresponding input assigned to the sub-screen is set by a user.

9. An apparatus for using an electronic device, the apparatus comprising:
a display unit having a touch screen;
a Wireless Local Area Network (WLAN) module; and
a controller configured to control the WLAN module to transmit display data resulting from running an application to an external output device while in a screen share mode for the running application, to control the display unit to display an input interface in a display screen of the display unit, and to control operations of the application according to inputs to the displayed input interface.

10. The apparatus of claim 9, wherein the controller controls the display unit to display a list of input interfaces, receives a selection of an input interface, and controls the display unit to display the selected input interface.

11. The apparatus of claim 9, wherein the controller divides the display screen into sub-screens, assigns inputs to the sub-screens, and controls the display unit to display the sub-screens.

12. The apparatus of claim 11, wherein the controller, upon detection of a touch input to any of the sub-screens, controls operations of the application based on an input assigned to the sub-screen where the touch input is detected.

13. The apparatus of claim 11, wherein the controller activates only a sub-screen on which a touch input is detected, and controls operations of the application based on a corresponding input assigned to the activated sub-screen, according to the touch input to the activated sub-screen.

14. The apparatus of claim 13, wherein the controller deactivates other sub-screens than the sub-screen in which the touch input is detected.

15. The apparatus of claim 11, wherein the controller, if a touch input starting in a sub-screen and ending in another sub-screen is made, controls operations of the application based on a corresponding input assigned to the sub-screen in which the touch input begins, according to the touch input.

16. The apparatus of claim 11, wherein any of the number of sub-screens, a size of each sub-screen or the input assigned to the sub-screen, is set by a user.

17. At least one non-transitory processor readable medium for storing a computer program of instructions configured to be readable by at least one processor for instructing the at least one processor to execute a computer process for performing the method as recited in claim 1.
